(19) United States
(12) Patent Application Publication
(10) Pub. No.: US 2004/0192382 A1
(43) Pub. Date: Sep. 30, 2004

(54) Personal digest delivery system and method

(76) Inventors: Takako Hashimoto, Tokyo (JP); Atsushi Iizawa, Tokyo (JP); Masayuki Kameda, Kanagawa (JP)

Correspondence Address: DICKSTEIN SHAPIRO MORIN & OSHINSKY LLP, 2101 L STREET NW, WASHINGTON, DC, 20037-1526, US

(21) Appl. No.: 10/352,046

(22) Filed: Jan. 28, 2003

(30) Foreign Application Priority Data
Jan. 29, 2002 (JP) 2002-020692
Mar. 29, 2002 (JP) 2002-097884
Nov. 12, 2002 (JP) 2002-328715

(51) Int. Cl. H04Q 7/20

(52) U.S. Cl. 455/556.2

(57) ABSTRACT

A personal digest delivery system can automatically create and deliver a higher quality digest promptly. The personal digest delivery system comprises a field processing apparatus creating meta data and a digest candidate scene in the field and sending the meta data and the digest candidate scene to an exterior of the field, a digest processing apparatus creating a personal digest from the sent meta data and preference information and exhibiting the personal digest to a user, and a moving image delivery processing apparatus editing the digest candidate scene in accordance with the personal digest so as to create moving image data and delivering the moving image data to a mobile terminal of the user.

### BACKGROUND OF THE INVENTION

1. Field of the Invention

The present invention generally relates to digest delivery systems and methods that deliver to a mobile terminal, for example, a digest scene of a live broadcast of a sports program, and more particularly to a personal digest delivery system and method that can deliver a digest suitable to the preference of an individual user.

2. Description of the Related Art

Recently, there has been a rapid spread of mobile terminals such as a cellar phone and a PDA (Personal Digital Assistant). Among the next generation mobile terminals being used on trial, there is a mobile terminal that can receive not only text and still images but also moving images by using the network bandwidth of 384 Kbps in the maximum. Such a mobile terminal is expected to realize higher functions such as sound processing.

On the other hand, a mobile terminal is used to deliver a flash of a sports game such as baseball and soccer at present. In a currently available service, a user can receive character-based information such as “1st bottom Team G: 3—Team C: 1; Team G goes ahead by a hit of the player T” through a mobile terminal every time the teams make a score or an inning is changed.

According to the above-mentioned service, the user can obtain information regarding the game even while the user is traveling. The current service mainly provides character-based information regarding the game to the user. However, improvement of mobile terminals will realize the delivery of information regarding the game as moving image information in future.

Also, especially in the delivery of information regarding a sports game, each user tends to want information different from the other users, for example, the user may want information regarding only a certain team or only a certain player. In the future, it is predicted that an individual user can receive information specifically aiming at the user. Under the above background, some methods for automatically extracting a scene in accordance with a game condition and user's preference with respect to a favorite team and then producing character-based information to explain the extracted scene have been presented.

However, in a conventional delivery service, a portion of a picture having a certain content is simply extracted without consideration of information value and is delivered to a user. As a result, the delivered image contains valueless information and few scenes in which the user can recognize a player's facial expression.

Additionally, in a conventional technique, there is room to improve the arrangement of programs and data to implement a system for delivering the scene extracted in accordance with the user's preference and the character-based information to explain the scene by using a network.

In a mobile apparatus on which various restrictions such as a restricted display area are imposed, it is impossible to set such a detailed profile that can be commonly set in the Internet due to the restricted display area and poor operability. In a conventional technique, since it is presumed that the user's preference information is sufficiently set even in a mobile environment in which there are some restrictions with respect to operability, it is impossible to efficiently produce a digest in accordance with the user's preference.

### SUMMARY OF THE INVENTION

It is a general object of the present invention to provide an improved and useful personal digest delivery system and method in which the above-mentioned problems are eliminated.

A first specific object of the present invention is to provide a personal digest delivery system and method that can deliver a higher quality image in a delivery service for delivering a scene extracted in accordance with the preference of a user and character-based information to explain the scene to a mobile terminal of the user.

A second specific object of the present invention is to provide a personal digest delivery system that has an arrangement of programs and data suitable to improve the processing efficiency in the delivery service for delivering the scene extracted in accordance with the preference of a user and character-based information to explain the scene to a mobile terminal of the user.

A third specific object of the present invention is to provide a personal digest delivery system that can efficiently create a digest in accordance with the preference of a user in a restricted environment such as the limited display area of a mobile terminal.

In order to achieve the above-mentioned objects, there is provided according to one aspect of the present invention a personal digest delivery system for delivering a personal digest of an image to a mobile terminal of a user, comprising: a field processing apparatus having a meta data creating part provided in a field in which an event to be imaged arises, the field processing apparatus generating meta data of the image, a digest candidate scene creating part extracting a portion of the image and creating a digest candidate scene, and a meta data digest candidate scene sending part sending the meta data and the digest candidate scene; a digest processing apparatus having a meta data receiving part receiving the meta data sent by the meta data digest candidate scene sending part, a personal digest creating part creating the personal digest for the user based on the meta data and preference information of the user, a personal digest exhibiting part exhibiting the personal digest to the user, and a receiving part receiving from the user a request for delivery of moving image data; and a moving image delivery processing apparatus having a digest candidate scene receiving part receiving the digest candidate scene from the field processing apparatus, and a moving image data delivery part delivering the moving image data formed of at least a portion of the digest candidate scene to the mobile terminal of the user.

According to the above-mentioned invention, the field processing apparatus provided in the field in which an event to be imaged occurs creates and sends meta data and a digest candidate scene. Based upon the digest candidate scene and preference information that an individual user has registered in advance, the digest processing apparatus creates a personal digest for the user. The moving image delivery processing apparatus exhibits the personal digest to the user. As a result, it is possible to provide a personal digest delivery system that can automatically create a digest promptly in a mobile environment. Furthermore, the personal digest delivery system can deliver a moving image in accordance with a request of the user.

Also, data and information are communicated and delivered among the field processing apparatus, the digest processing apparatus and the moving image delivery processing apparatus via a network. Since the personal digest delivery system according to the present invention has the information for creating meta data based upon the analysis result of semantic contents of an image, the information for extracting a digest candidate scene, the preference information of an individual user, the information regarding the created digest, and programs for creating the above information in the network, it is possible for the personal digest delivery system according to the above-mentioned invention to dynamically create and deliver a personal digest.

In the above-mentioned personal digest delivery system, the digest processing apparatus further may have a meta data storage part storing the meta data that the meta data receiving part receives and a preference information storage part storing the preference information of the user in advance, and the personal digest creating part may create the personal digest from the meta data stored in the meta data storage part and the preference information of the user stored in the preference information storage part.

According to the above-mentioned invention, the digest processing apparatus stores an identifier and information regarding a preference item of an individual user in the preference information storage part in advance. Based upon the meta data and the preference information in the preference information storage part, the personal digest creating part creates a personal digest. As a result, it is possible for the personal digest delivery system according to the above-mentioned invention to efficiently create the personal digest reflecting the user's preference and provide the personal digest to the user.

In the above-mentioned personal digest delivery system, the moving image delivery processing apparatus further may have a digest candidate scene storage part storing the digest candidate scene that the digest candidate scene receiving part receives, and the moving image data delivery part may deliver the moving image data created from the digest candidate scene stored in the digest candidate scene storage part to the mobile terminal of the user.

According to the above-mentioned invention, it is possible to deliver moving image data created from a digest candidate scene in the digest scene storage part to a user.

In the above-mentioned personal digest delivery system, the moving image data delivery part, when the receiving part of the digest processing apparatus receives a request for the moving image data delivery, may read the digest candidate scene based on the personal digest and deliver the moving image data created by editing the digest candidate scene to the mobile terminal of the user that sends the request.

According to the above-mentioned invention, the field processing apparatus provided in the field in which an event to be imaged occurs extracts a digest candidate scene. Based upon the personal digest in accordance with the user's preference, the extracted digest candidate scene is edited. The moving image delivery processing apparatus exhibits the edited scene as moving image data to the user's terminal. Also, when the personal digest delivery system receives a request, the personal digest delivery system can deliver the moving image data to the user's terminal. As a result, it is possible to automatically create a digest promptly in a mobile environment.

In the above-mentioned personal digest delivery system, the field processing apparatus may be provided in a playing field of a sports program such as soccer and baseball and generate the meta data of the sports program.

According to the above-mentioned invention, the field processing apparatus is provided in a playing spot of a sports game. As a result, the field processing apparatus can automatically create a digest promptly.

In the above-mentioned personal digest delivery system, the field processing apparatus may send the meta data of the sports program and the digest candidate scene to the digest processing apparatus in one of in real time and at an intermission of the sports program.

According to the above-mentioned invention, the field processing apparatus sends program meta data and a digest candidate scene to the digest processing apparatus in real time or at an intermission of a sports game. As a result, it is possible to analyze the program content without much delay compared to the live sports program.

In the above-mentioned personal digest delivery system, the meta data that the field processing apparatus generates may be content description data describing the digest candidate scene.

According to the above-mentioned invention, the field processing apparatus creates the content description data to describe a digest candidate scene as meta data. As a result, it is possible to easily analyze the content of the digest candidate scene by using meta data. It is noted that the content description data may be a simple description such as index information.

In the above-mentioned personal digest delivery system, the digest processing apparatus may analyze the importance of the digest candidate scene based on the meta data stored in the meta data storage part and further may have a digest server writing an analysis result in the meta data storage part.

According to the above-mentioned invention, the digest processing apparatus analyzes the importance of a digest candidate scene based upon meta data in the meta data storage part and stores the digest candidate scene sent from the field processing apparatus. As a result, it is possible to receive data from the field processing apparatus and analyze the program in parallel.

In the above-mentioned personal digest delivery system, the digest server may regularly examine an update of the meta data, and the digest server may analyze the importance of the digest candidate scene and write the analysis result in the meta data storage part immediately after the meta data are updated.

According to the above-mentioned invention, just after the update of data is found, the digest processing apparatus analyzes the importance of the digest candidate scene and writes the analysis result in the meta data storage part. As a result, it is possible to update the analysis result without much delay after the update of meta data.

In the above-mentioned personal digest delivery system, the digest processing apparatus further may have a scene ranking module having a function of ranking the digest candidate scene by using said preference information of the user.

According to the above-mentioned invention, the scene ranking module ranks a digest candidate scene based upon the preference information in the preference information storage part. As a result, it is possible to perform the ranking process for the scene for an individual user separately from the digest process.

In the above-mentioned personal digest delivery system, the digest processing apparatus may store an identifier and information regarding a preference item in the preference information storage part as the preference information of the user.

According to the above-mentioned invention, the digest processing apparatus stores the identifier and the information of the preference item of a user in the preference information storage part as the preference information of the user. When the user's preference information is registered for each preference item, it is possible to perform a flexible preference process for a digest corresponding to each piece of the preference information and create a personal digest for an individual user.

In the above-mentioned personal digest delivery system, the digest processing apparatus may extract an identifier of the user from access information of the user, determine an item of the personal digest to be exhibited to the user based on the preference information of the user that the user registers in advance and the meta data stored in the meta data storage part, issue a digest creating request to the scene ranking module and create the personal digest.

According to the above-mentioned invention, the digest processing apparatus extracts the identifier of a user based upon access information of the user and determines what item of personal digest should be exhibited to the user based upon the preference information that the user has registered in advance and the program meta data in the meta data storage part. Based upon the determined item of personal digest, a request for creating a digest is issued to the scene ranking module and a personal digest is created. As a result, it is possible to efficiently create a digest reflecting the user's preference in the mobile environment in which there are some restrictions such as the limited display area.

In the above-mentioned personal digest delivery system, a plurality of the field processing apparatuses may be provided at a plurality of the fields and each of the field processing apparatuses may be located in one of the fields and process the image of an event arising in the field in which the field processing apparatus is located.

According to the above-mentioned invention, each of the field processing apparatuses can process a moving image of an event to be imaged arising in a plurality of distinct fields.

Additionally, there is provided according to another aspect of the present invention a personal digest delivery method for delivering a personal digest of an image to a mobile terminal of a user, the personal digest delivery method comprising: a meta data creating step of creating meta data of the image in a field in which an event to be imaged arises; a digest candidate scene creating step of extracting a portion of the image and creating a digest candidate scene; a personal digest creating step creating a personal digest for the user based on the meta data and preference information of the user; a personal digest exhibiting step of exhibiting the personal digest to the user; and a moving image data delivery step of delivering moving image data created from at least a portion of the digest candidate scene to the mobile terminal of the user.

According to the above-mentioned invention, meta data and a digest candidate scene are created in the field in which an event to be imaged occurs. Based upon the digest candidate scene and the preference information that an individual user has registered in advance, a personal digest is created and exhibited for the individual user. As a result, it is possible to automatically create a digest promptly in the mobile environment.

Other objects, features and advantages of the present invention will become more apparent from the following detailed description when read in conjunction with the accompanying drawings.

### BRIEF DESCRIPTION OF THE DRAWINGS

FIG. 1 is a block diagram roughly illustrating a structure of a personal digest delivery system according to a first embodiment of the present invention;

FIG. 2 is a diagram illustrating a procedure of the personal digest delivery system in detail;

FIG. 3 is a diagram illustrating a process of a field processing apparatus of the personal digest delivery system according to the first embodiment;

FIG. 4 is a flowchart of the process of the field processing apparatus;

FIG. 5 is a diagram illustrating a process of a digest processing apparatus of the personal digest delivery system according to the first embodiment;

FIG. 6 is a flowchart of the process of the digest processing apparatus;

FIG. 7 is a diagram illustrating an operation of the personal digest delivery system according to the first embodiment when the personal digest delivery system is accessed by a user;

FIG. 8 is a flowchart illustrating the operation of the personal digest delivery system according to the first embodiment when the personal digest delivery system is accessed by a user;

FIG. 9 is a block diagram roughly illustrating a structure of a personal digest delivery system according to a second embodiment of the present invention;

FIG. 10 is a diagram illustrating a data flow when program meta data and digest candidate scenes are stored under the personal digest delivery system according to the second embodiment;

FIG. 11 is a diagram illustrating a data flow when a digest server of the personal digest delivery system according to the second embodiment performs an analysis;

FIG. 12 is a diagram illustrating a data flow between a digest processing apparatus and a moving image delivery processing apparatus of the personal digest delivery system according to the second embodiment;

FIG. 13 is a flowchart of an access process of a user in the digest processing apparatus of the personal digest delivery system according to the second embodiment;

FIG. 14 is a diagram illustrating an example of storage of a moving image (a digest candidate scene) and meta data in the personal digest delivery system according to the second embodiment; and

FIG. 15 is a diagram illustrating access of a user (a mobile terminal) in the personal digest delivery system according to the second embodiment.

### DETAILED DESCRIPTION OF THE PREFERRED EMBODIMENTS

In the following, embodiments of the present invention will be described with reference to the accompanying drawings. The following embodiments of the present invention focus on a personal digest delivery system that is mainly applied to a personal digest delivery of a live broadcast of a sports game.

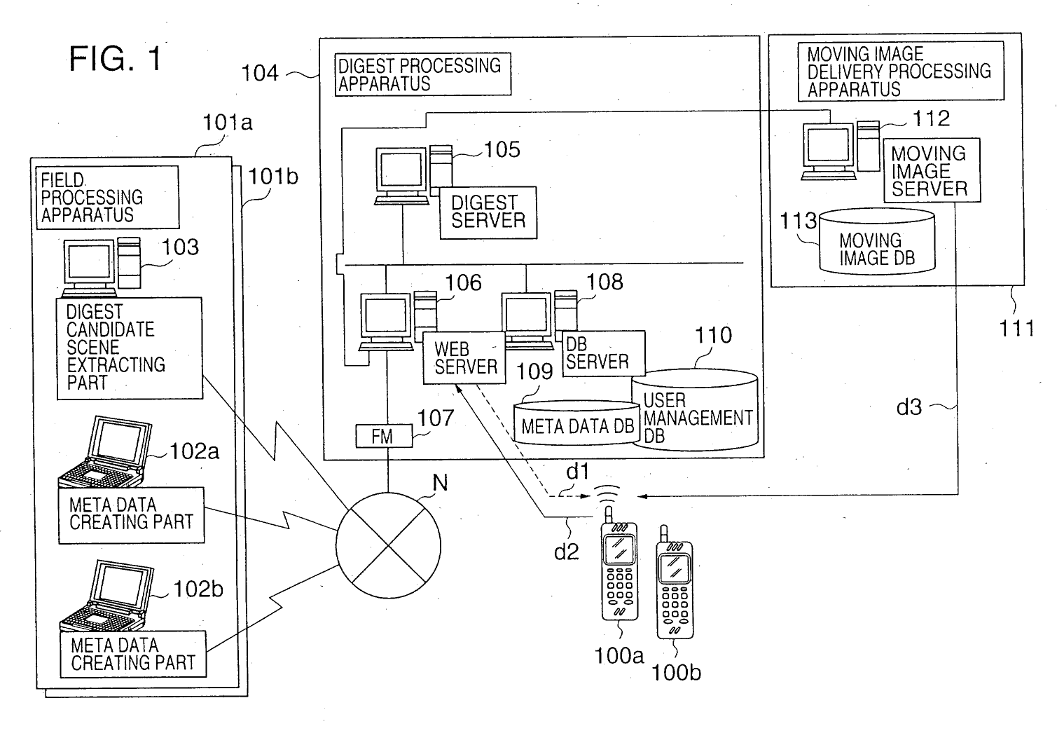

FIG. 1 is a diagram illustrating a configuration of a personal digest delivery system according to the first embodiment of the present invention. In the personal digest delivery system, a personal digest of an image is delivered to users' mobile terminals (a cellar phone or a personal handyphone) 100a, 100b, . . . . The personal digest delivery system comprises a field processing apparatus 101 provided in the field where there occurs an event to be imaged, a digest processing apparatus 104 producing a personal digest in accordance with preferences of an individual user and exhibiting the personal digest to the user, and a moving image delivery processing apparatus 111 delivering a moving image in accordance with the personal digest to the user.

In this embodiment, the event to be imaged is a sports game, and the field is the place where the sports game is held. In order to deal with a plurality of games broadcast from different fields, a field processing apparatus 101 is provided in each of the fields. Accordingly, the personal digest delivery system according to the first embodiment comprises a plurality of field processing apparatuses 101a, 101b, . . . . Hereinafter, especially if it is unnecessary to distinguish between the individual field processing apparatuses, the field processing apparatuses are referred to as the same reference numeral 101 without specifying any of the field processing apparatuses 101a, The field processing apparatus 101 comprises a meta data creating part 102 creating meta data of an image, a digest candidate scene extracting part 103 extracting a portion of an image so as to produce a digest candidate scene, a network N sending the meta data to the digest processing apparatus 104 and the digest candidate scene to the moving image delivery processing apparatus 111, and FW (Fire Wall) 107 protecting the personal digest delivery system against a hacker. Here, if a plurality of meta data creating parts 102a, 102b, . . . are provided in the individual field processing apparatuses 101, it is possible to simultaneously create a plurality of pieces of meta data. Hereinafter, especially without a necessity to do otherwise, the meta data creating parts 102a, 102b, . . . are simply referred to as the meta data creating part 102.

The digest processing apparatus 104 comprises a Web server 106 such as a WWW (World-Wide Web) server receiving meta data via the network N, a meta data DB (database) 109 for storing the received meta data, a user management DB 110 for storing preference information of users, and a digest server 105 creating a personal digest based upon the meta data and the preference information. Each personal digest is exhibited as personal digest data d1 to the user of one of mobile terminals 100a, 100b, . . . by the Web server 106. Also, the meta data DB 109 and the user management DB 110 are connected to the digest server 105 via the DB server 108. The user management DB forms a preference information storage part according to the present invention, and the Web server 106 forms a personal digest exhibiting part and a receiving part according to the present invention.

The moving image delivery processing apparatus 111 comprises a moving image server 112 receiving a digest candidate scene sent from the field processing apparatus 101, and a moving image DB 113 for storing the received digest candidate scene. The moving image server 112 delivers to a user moving image data d3 formed of at least a portion of the received digest candidate scene. The moving image server 112 forms a digest candidate scene receiving part according to the present invention, and the moving image DB 113 forms a digest candidate scene storage part.

In the above-mentioned personal digest delivery system, the moving image delivery processing apparatus 111 reads a digest candidate scene from the digest candidate scene storage part in accordance with a personal digest produced by the digest server 105 and creates moving image data d3 by editing the read digest candidate scene.

When the personal digest is exhibited to a user, the user determines whether or not to request delivery of a moving image with reference to the personal digest. If the user determines to request the delivery, the user sends request data d2 from the user's mobile terminal (for example, 100a) to the Web server 106. When the digest processing apparatus 104 receives the request data d2, the digest processing apparatus 104 informs the moving image delivery processing apparatus 111 and sends the personal digest. The moving image server 112 of the moving image delivery processing apparatus 111 reads a digest candidate scene from the moving image DB 113 in accordance with the personal digest and produces moving image data d3 by editing the digest candidate scene. Then, the moving image delivery processing apparatus 111 delivers the moving image data d3 to the user's mobile terminal.

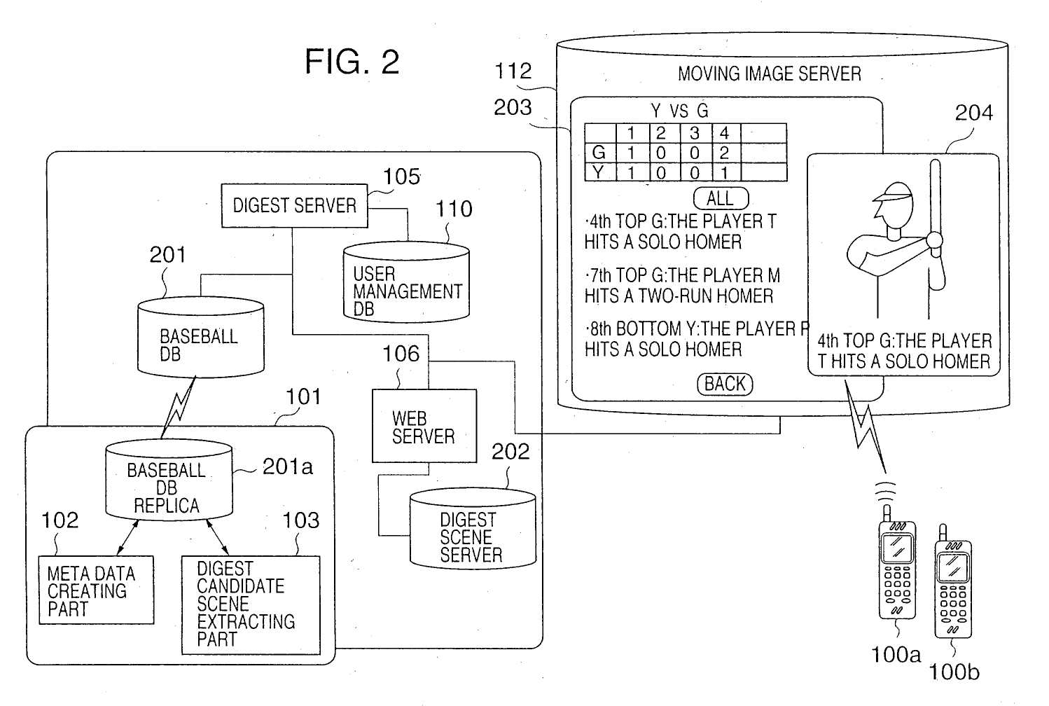

FIG. 2 is a diagram illustrating the above-mentioned procedure of the personal digest delivery system in detail. The meta data creating part 102 of the field processing apparatus 101 creates meta data from a broadcast image of a sports game in real time.

The digest candidate scene extracting part 103 sequentially extracts a digest candidate scene that is likely to become a digest scene from the images based upon progress of the game. For example, the digest candidate scene is as follows;

Case 1: Baseball Game Image

The last pitch for a batter in each at-bat (the pitch resulting in three strikes, a hit or the like)

A scene of a stolen base or a pick-off throw

A scene of an irregular event such as a brawl or an error

Case 2: Soccer Game Image

A goal scene

A scene of fine fielding

In this embodiment, since the above data are extracted as a digest candidate scene and the digest candidate scene is edited, it is possible to set only a spotlight scene as the digest scene. Also, since the scene is edited in accordance with the user's preference, it is possible to produce high quality moving data.

Additionally, in this embodiment, since the field processing apparatus 101 produces meta data simultaneously to the extraction of the digest candidate scene, it is possible to easily produce meta data associated with individual digest candidate scenes.

A replica 201a of a baseball DB 201 for storing meta data and digest candidate scenes is formed in the field processing apparatus 101. Whenever an inning is finished, the meta data and the digest candidate scene are sent to the replica 201a of the baseball DB 201. Then, the meta data and the digest candidate scene are sent to the baseball DB 201 and are stored therein. In the case of an image of a baseball broadcast, the baseball DB 201 in FIG. 2 is a database having two functions as the meta data DB 109 and the moving image DB 113.

The user management DB 110 serves to maintain and manage preference information and access logs of users. When the Web server 106 receives the request data d2 from a user, the digest server 105 reads the preference information of the user from the user management DB 110. The preference information includes the user's preference for the following events: What team and what player does the user expect to watch? Does the user like a scene of a home run? Does the user like a scene of a brawl? A personal digest is dynamically produced based upon the preference information and the meta data in the baseball DB 201.

The personal digest is formed of a digest candidate scene, character-based information to explain a moving image produced from the digest candidate scene, and an identification number to identify the digest candidate scene. The produced personal digest is exhibited to the user. In FIG. 2, a personal digest 203 is illustrated as an example of the above-mentioned personal digest. The personal digest 203 includes data such as team names playing the game “Y vs G” and a score table of the game and character-based information to explain a moving image, for example, “4th Top G: The player T hits a solo homer.” and “8th Bottom G: The player P hits a solo homer.”

When the user reads the character-based information in the personal digest and determines what moving image the user would like to be delivered, a digest candidate scene required to produce the moving image is retrieved from the baseball DB 201 and is sent to the digest scene server 202. The Web server 106 produces a Web file from the personal digest 203 and the digest candidate scene and delivers the Web file to mobile terminals of the user 100a, 100b, . . . via the moving image server 112. In FIG. 2, a scene of the delivered moving image is referred to by reference numeral 204.

In the above method, the digest processing apparatus 104 produces a personal digest from preference information and meta data under the personal digest delivery system according to the first embodiment. A digest candidate scene, which is used to create a moving image, is edited in accordance with the personal digest. The edited moving image is delivered from the baseball DB 201 (the moving image DB 113) of the moving image delivery processing apparatus. Accordingly, since an image itself does not have to be processed in the digest processing apparatus 104, it is possible to enhance the processing efficiency of the digest processing apparatus 104.

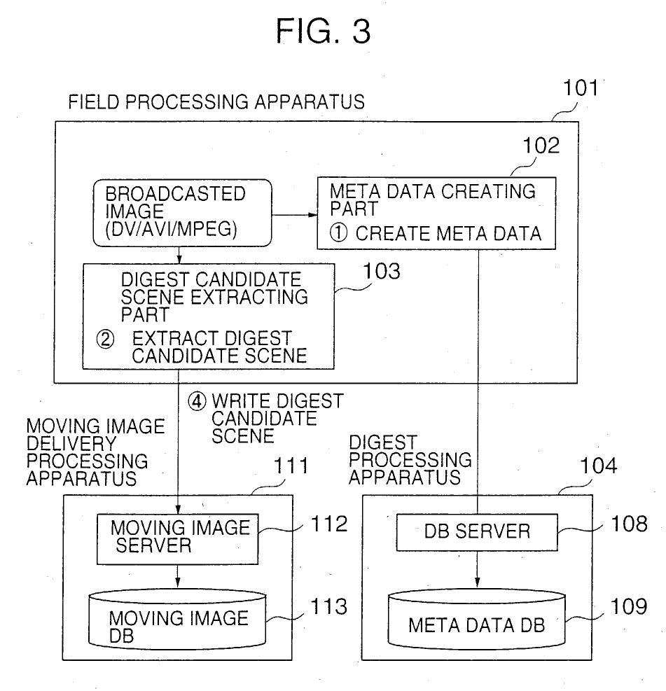

A description will now be given, with reference to FIG. 3 through FIG. 8, of a delivery method of the personal digest delivery system according to the first embodiment of the present invention.

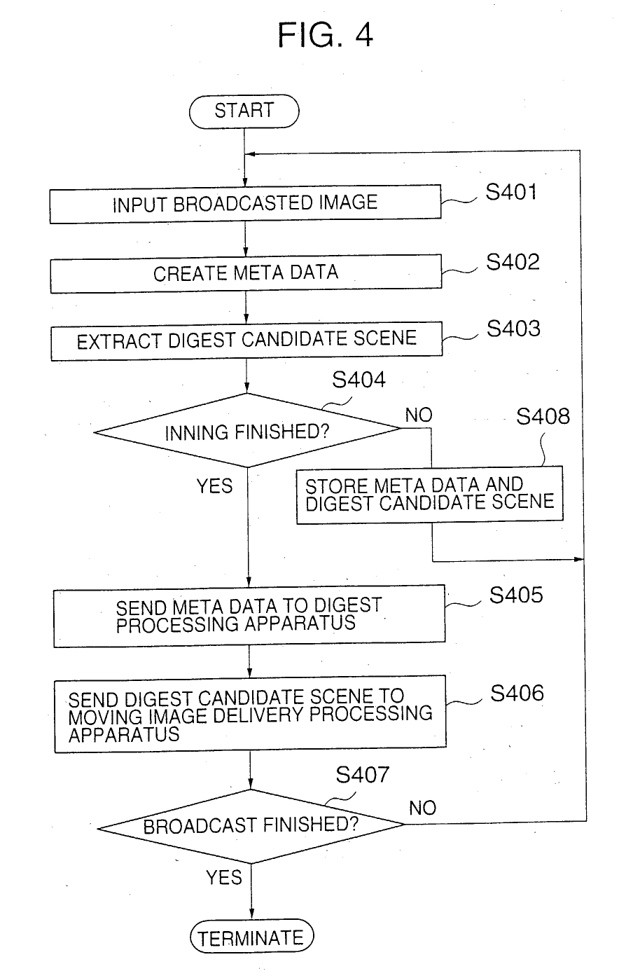

FIG. 3 is a diagram illustrating a process of the field processing apparatus 101, and FIG. 4 is a flowchart of the process. In the field processing apparatus 101, the meta data creating part 102 and the digest candidate scene extracting part 103 receive a broadcast image of a sports game (step S401). Here, the image is assumed to follow standards such as DV (Digital Video), AVI (Audio Video Interleaved) and MPEG (Moving Pictures Experts Group).

The meta data creating part 102 produces meta data of the input image (step S402). Also, the digest candidate scene extracting part 103 extracts a digest candidate scene that is expected to become a digest scene (step S403). In this embodiment dealing with baseball, it is determined whether or not each inning of the game is finished (step S404). If the inning is finished (step S404: YES), meta data produced by the meta data creating part 102 are sent to the DB server 108 of the digest processing apparatus 104 (step S405). Also, the extracted digest candidate scene is sent to the moving image server 112 of the moving image delivery processing apparatus 111 (step S406). If it is determined that the inning is not finished (step S404: NO), the meta data and the digest candidate scene are stored in the field processing apparatus 101 (step S408).

Then, it is determined in the field processing apparatus 101 whether or not the broadcast of the game is finished (step S407). If not (step S407: NO), an image to be broadcasted is received and the above-mentioned process is repeated. If it is determined that the broadcast of the game is finished (step S407: YES), the process is terminated.

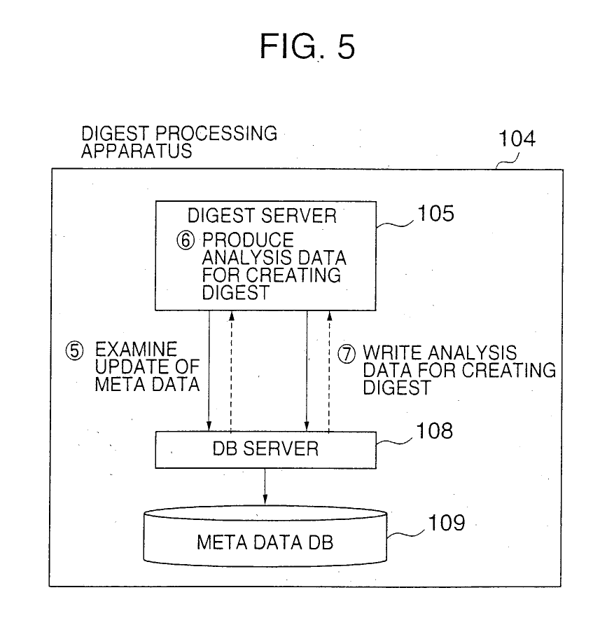

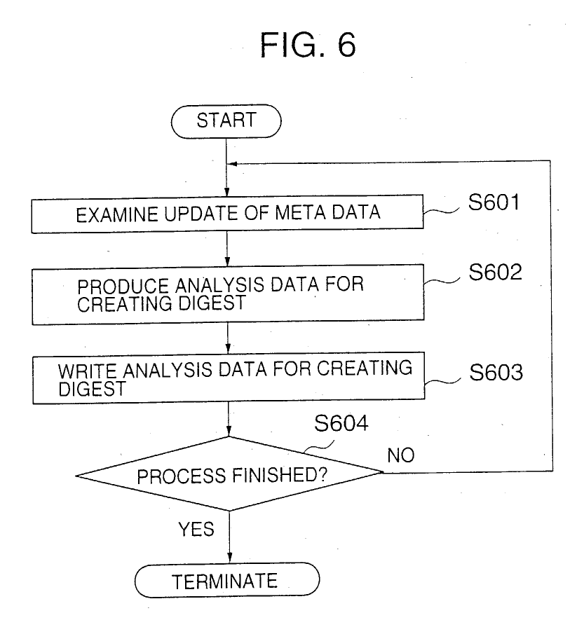

FIG. 5 is a diagram illustrating a process of the digest processing apparatus 104, and FIG. 6 is a flowchart of the process. In the digest processing apparatus 104, the digest server 105 examines an updating status of the meta data DB 109 (step S601), and meta data are used to produce analysis data for creating a digest (step S602). Then, the produced analysis data are written in the meta data DB 109 via the DB server 108 (step S603). Here, the inventors of the present invention have already presented the content of the analysis data for creating a digest and the description thereof will be omitted.

For every broadcasted image of a game, the digest processing apparatus 104 determines whether or not the updating status of the meta data has been already examined and the analysis data have been already produced (step S604). If not (step S604: NO), the updating status of the meta data continues to be examined. On the other hand, if so (step S604: YES), the process is terminated.

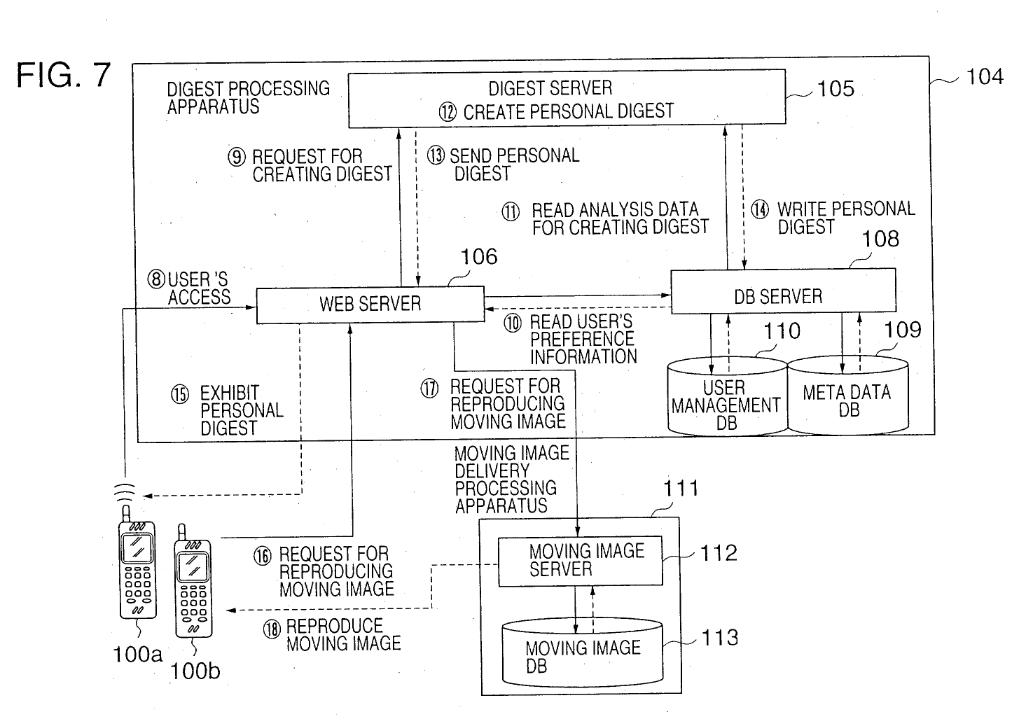

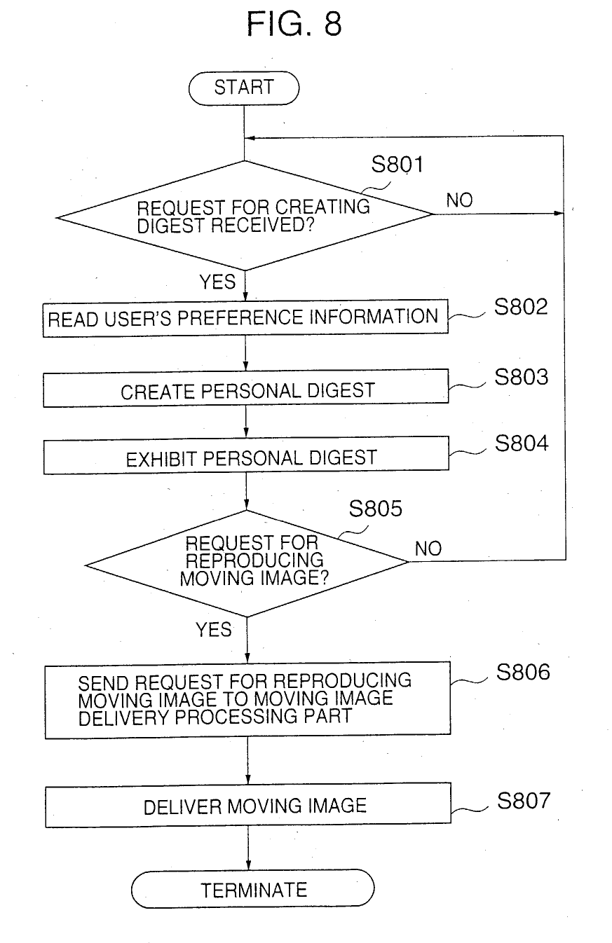

Then, a description will now be given, with reference to FIG. 7 and FIG. 8, of an operation of the personal digest delivery system when the personal digest delivery system is accessed by a user. In this case, the Web server 106 determines whether or not a request for creating a digest is received (step S801). If the user has access to the personal digest delivery system and requests to create the digest, it is determined that the request has been received (step S801: YES). If the user does not request the digest delivery (step S801: NO), the digest processing apparatus 104 waits until the request is received.

When the digest creation is requested, the Web server 106 informs the digest server 105 of the digest creation. Then, the Web server 106 has access to the user management DB 110 via the DB server 108 and reads the preference information of the user who requests the digest creation (step S802). The digest server 105 reads the analysis data for the digest creation via the DB server 108 and creates the personal digest in accordance with the preference information (step S803).

After the produced personal digest is sent to the Web server 106 and is written in the user management DB 110 via the DB server 108, the personal digest is exhibited to the user via the terminal 100a and 100b (step S804). Then, the Web server 106 determines whether or not a request to reproduce a moving image is received from the user (step S805).

If it is determined that the request for reproducing the moving image is received (step S805: YES), the Web server 106 provides the request and the personal digest to the moving image server 112 of the moving image delivery processing apparatus 111 (step S806). Based upon the personal digest, the Web server reads and edits a digest candidate scene in the moving image DB 113. The edited moving image is delivered to the user (step S807).

A personal digest delivery system according to the second embodiment of the present invention uses preference information that a user registers in advance and delivers a dynamically produced personal digest corresponding to progress of the game. Based upon the user's preference information, a specification of the personal digest to be produced is automatically determined. Based upon the specification, the ranking of a digest candidate scene is determined for the user and becomes a constituent of the personal digest.

The personal digest delivery system according to the second embodiment comprises a field processing apparatus describing the fundamental content of an image of a sports game, a digest processing apparatus performing a digest process and controlling a screen for a user and access of the user, a moving image delivery processing apparatus storing and delivering a moving image. The field processing apparatus extracts a scene that may become a digest candidate scene and edits the extracted scene. Meta data are generated as supplemental information regarding the digest candidate scene. If the extracted digest candidate scene and the corresponding meta data are sent in real time or during each intermission of the broadcast, it is possible to determine importance of the digest candidate scene soon after the extracted digest candidate scene and the corresponding meta data are received.

An identifier and a preference item of a user are stored as the user's preference information in a user DB. Based upon the above information and information regarding the digest candidate scene, if there is a scene associated with the preference item of the user, the importance of the scene is ranked higher and the personal digest is created. As a result, the user can efficiently obtain a digest by setting less preference information.

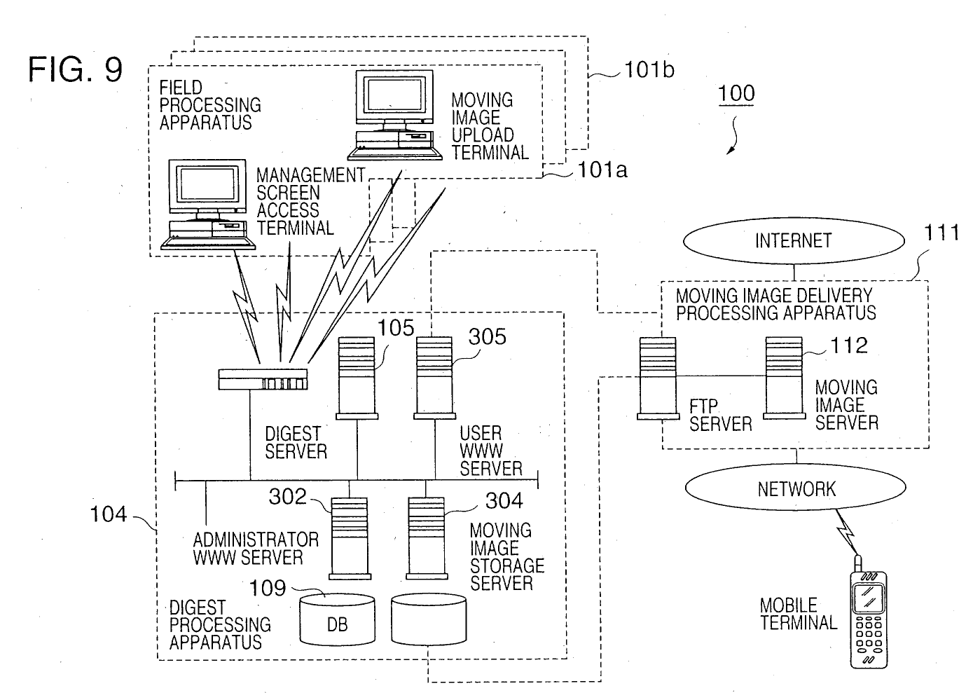

FIG. 9 is a block diagram roughly illustrating a structure of the personal digest delivery system according to the second embodiment of the present invention. A personal digest delivery system 100 comprises a field processing apparatus 101 producing and sending program meta data and a digest candidate scene in the broadcast field of a sports game, a digest processing apparatus 104 selecting a digest candidate scene for an individual user and generating a personal digest for the individual user based upon the program meta data and the digest candidate scene that are sent from the field processing apparatus 101 together with the preference information that is registered by the individual user in advance and controlling access by the individual user, and a moving image delivery processing apparatus 111 storing and delivering the personal digest produced by the digest processing apparatus 104. It is noted that the personal digest delivery system is connected to the user's terminal via a wired or a wireless communication line or network. The individual apparatuses of the personal digest delivery system have to be connected to each other in such a communication environment that a moving image can be transmitted. In this embodiment, it is assumed that the field processing apparatus 101 is connected to the digest processing apparatus 104 by a wireless network and the digest processing apparatus 104 is connected to the moving image processing apparatus 111 by a private line.

The digest processing apparatus 104 does not process a broadcast image itself and only performs a ranking operation for a digest candidate scene that is created by the field processing apparatus 101, with reference to program meta data produced by the field processing apparatus 101. Thus, it is possible to efficiently create a digest. Additionally, if the digest processing apparatus 104 and the moving image delivery processing apparatus 111 are separately provided, it is possible to improve the efficiency of the moving image delivery process because of load distribution between the apparatuses.

A plurality of field processing apparatuses 101 are provided in some broadcasting relay spots. The field processing apparatuses 101 produce program meta data corresponding to the progress of a program. Then, the field processing apparatuses extract and edit a digest candidate scene corresponding to the program meta data. It is noted that a description of the creation of program meta data and the extraction and editing of a digest candidate scene is omitted because these operations can be performed by using techniques well known in the art. Also, the order of the creations of the program meta data and the digest candidate scene does not matter. As is shown in FIG. 9, the field processing apparatus 101 comprises management screen access terminals, whose roles are different from each other, and moving image upload terminals. The management screen access terminal serves to produce program meta data. The moving image upload terminal serves to edit and encode a digest candidate scene and then uploads the resulting digest candidate scene to the digest processing apparatus 104.

Information produced by the field processing apparatus 101 is sent to the digest processing apparatus 104 immediately whenever the information is produced or at the intermission when the program has a break in the meantime As the intermission, the time when an inning ends or an at-bat ends is supposed if the program is a baseball program.

When the program meta data are produced and sent as the information regarding the digest candidate scene, it is possible to efficiently produce meta data. Also, when the program meta data and the digest candidate scene are sent in real time or at the intermission of the program, it is possible to analyze program content without much delay.

The meta data produced by the field processing apparatus 101 explain a digest candidate scene. In fact, the program meta data include information such as: “Who appears on each digest candidate scene?” “What does the person do in the digest candidate scene?” “How is the digest candidate scene characterized?”

A digest in the personal digest delivery system according to the second embodiment is represented as a ranking of the digest candidate scenes for each user. As mentioned above, the program meta data are produced as information for explaining the digest candidate scene. As a result, it is possible to efficiently perform an analysis for generating a digest by analyzing only the content of the meta data.

The digest processing apparatus 104 comprises a meta data DB 301 for storing and managing meta data of baseball or soccer sent from the field processing apparatus 101, an administrator WWW server 302 serving to manage an interface to input the information and the input information, a digest server 105 analyzing the importance of a digest candidate scene based upon meta data in the meta data DB 109, and a moving image storage server 304 for storing a digest candidate scene sent from the field processing apparatus 101.

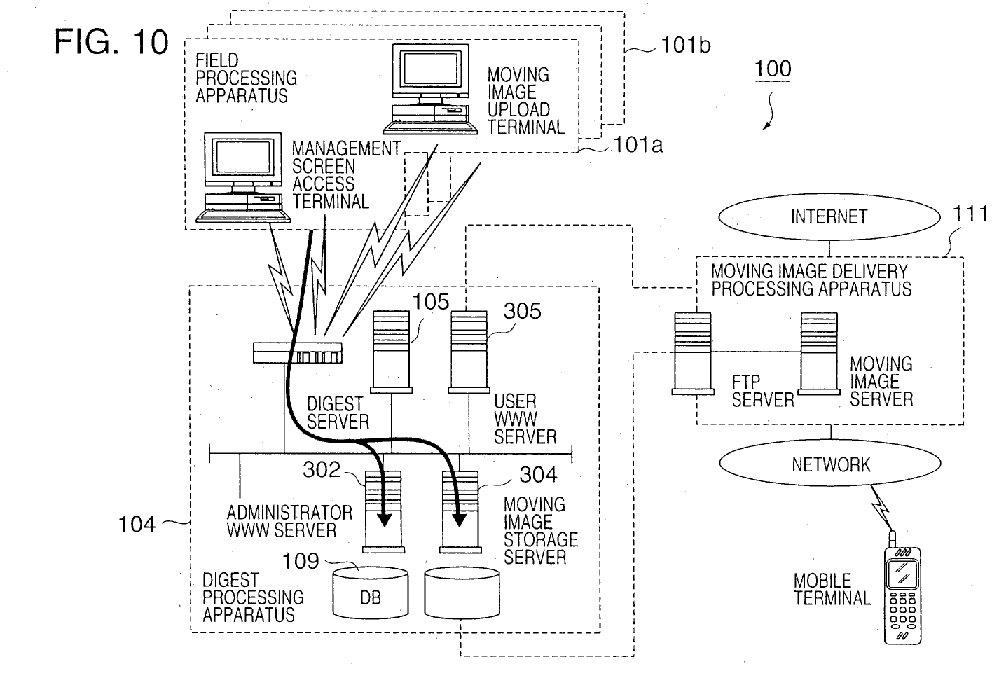

FIG. 10 shows a data flow for the program meta data and the digest candidate scene. The administrator WWW server 302 receives data from the field processing apparatus 101, stores the data in the meta data DB 109, and sends back a result to the field processing apparatus 101. In the field processing apparatus,101, it is possible to create meta data with reference to the result of the data stored in the meta data DB 109. Also, an extracted and edited digest candidate scene is sent from the field processing apparatus 101, and the sent digest candidate scene is stored in the moving image storage server 304 of the digest processing apparatus 104.

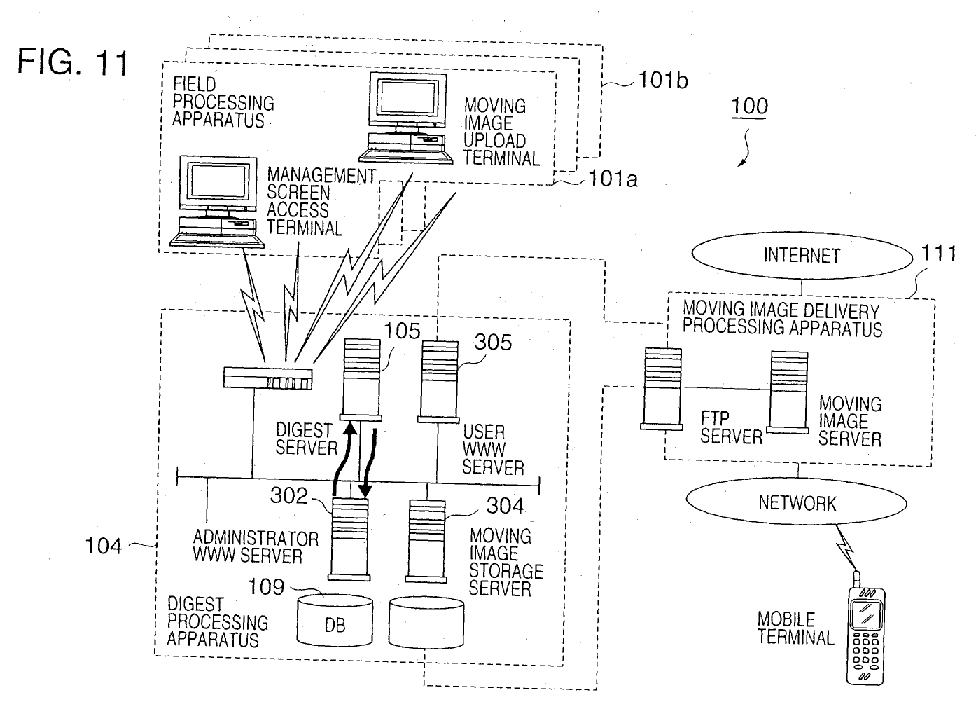

The digest server 105 operates separately from the administrator WWW server 302 and performs an analysis process by reading data in a DB written by the administrator WWW server 302. In this case, it is possible to receive data from the field processing apparatus 101 and perform a program analysis in parallel. FIG. 11 shows a data flow when the digest server 105 performs the analysis process.

Also, the digest server 105 examines the update of meta data. If the digest server finds the update of meta data, the digest server 105 starts a digest analysis process for analyzing the importance of a digest candidate scene and writes the analysis result in the meta data DB 109. In this process, the digest server 105 can analyze the program without much delay of the update of the meta data and derive the importance of the digest candidate scene.

The digest processing apparatus 104 comprises a user WWW server 305 managing access information of users and exhibiting the personal digests of individual users, a user DB (not illustrated) for managing the preference information of the users, and a scene ranking module ranking a digest candidate scene by using the data. Here, the scene ranking module operates as a process of the digest server 305.

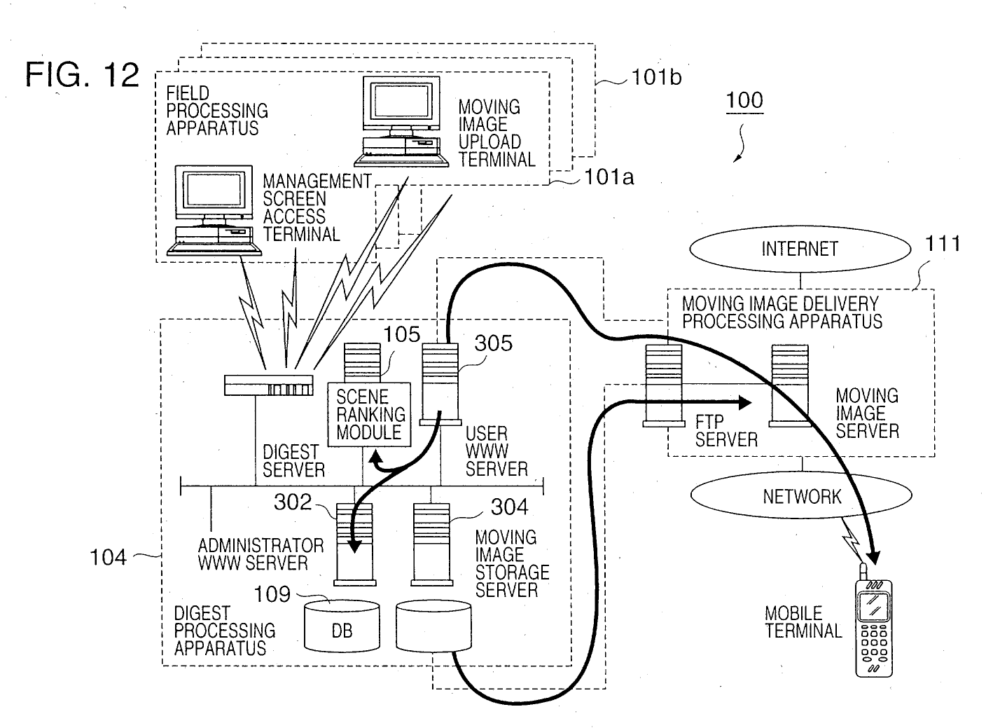

FIG. 12 shows a data flow between the digest processing apparatus 104 and the moving image delivery processing apparatus 111. When the user WWW server 305 receives a request for creating a digest from a user (mobile terminal) via a network and the moving image delivery processing apparatus 111, the user WWW server 305 reads the preference information corresponding to the user from the user DB and outputs the request for creating the digest to the digest server 105. When receiving the request for creating the digest, the digest server 105 executes the scene ranking module to create a personal digest for the user Here, a digest candidate scene in the moving image storage server 304 is uploaded by an FTP (File Transfer Protocol) server of the moving image delivery processing apparatus 111 in a predetermined interval of time (for example, an interval of five minutes) and the digest processing apparatus 104 and the moving image delivery processing apparatus 111 are synchronized.

When the administrator WWW server 302 and the user WWW server 305 are separated as shown in the above-mentioned configuration, it is possible to perform the work for an administrator and an access process as separated processes. Additionally, even if one of the administrator WWW server 302 and the user WWW server 305 has trouble, the separation of the two servers makes it possible for the other to serve as a substitute of the failed server. As a result, it is possible to enhance the reliability of the whole system. Also, when the preference information of users is stored in the user DB and the scene ranking module reads information from the meta data DB 109 and the user DB so as to rank a scene, it is possible to rank the scene for an individual user separately from the digest analysis process in the digest server 105.

An identifier and a preference item are stored as the preference information of a user in the user DB of the digest processing apparatus 104. For instance, if the program is a baseball program, the preference information is as follows;

An example of the preference information of a user:

(“User ID”, “Favorite Team ID”, “Favorite Player ID”): (100, 1, NULL), (100, NULL, 2001), (103, NULL, NULL), . . . .

In this example, the favorite team item and the favorite player item are included in the preference information. If there is a user (User ID=100) that likes the team Giants (Team ID=1) and the player Matsui (Player ID=2001), the two records (100, 1, NULL) and (100, NULL, 2001) are stored in the user DB. By using this preference information, a personal scene (digest candidate scene) is ranked. Additionally, when the preference information of a user is registered for each item, it is possible to flexibly perform a preference process corresponding to each preference information item.

Also, the digest processing apparatus 104 extracts a user identifier from the user access information and determines which personal digest item should be exhibited for each user from the preference information that the user has registered in advance and the program information in the meta data DB 109. Based upon the determination, the digest processing apparatus 104 issues a request for creating a digest to the scene ranking module and creates a personal digest.

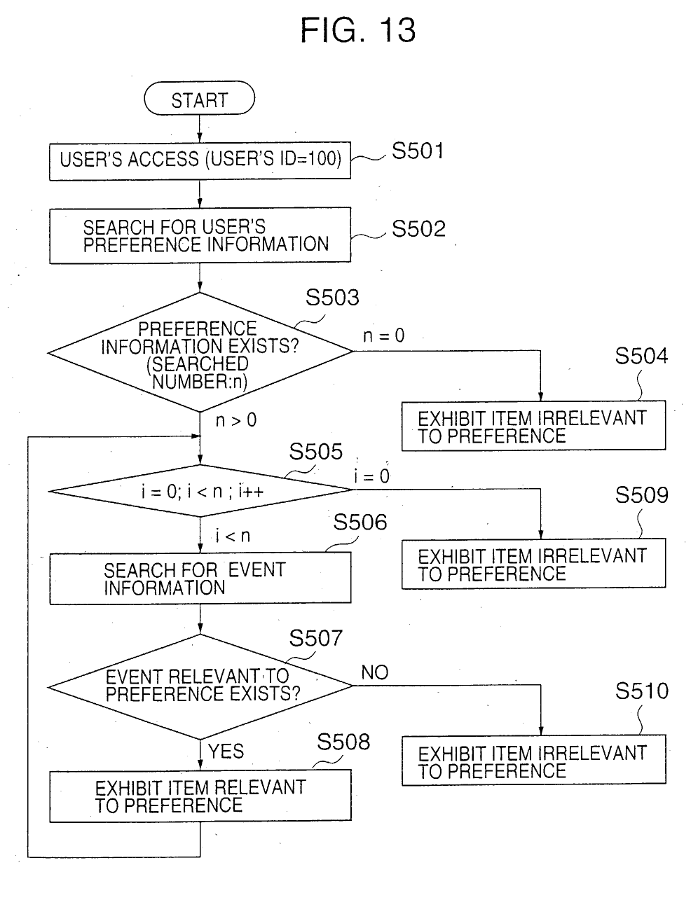

A description will now be given, with reference to a flowchart in FIG. 13, of an access process of a user with respect to the digest processing apparatus 104. It is assumed that a user having the user ID=100 has access of this system (S501). The above preference information is searched for by setting the user ID as a search key (S502). Although it is assumed that basically the preference information as mentioned above has already been registered in the user DB, the case in which the preference information is not registered should be considered.

Then, it is determined whether or not the preference information is registered (S503). If the preference information is not registered (n=0), an item irrelevant to preference (a menu) is exhibited to the user (mobile terminal) (S504). If the preference information is registered, it is determined whether or not there is a program that can currently be delivered as a digest for each piece of the preference information (S505 and S506). It is determined whether or not there is a scene relevant to the preference information of the user among digest candidate scenes available for delivery (S507). If a relevant scene is found, a digest suitable for the user's preference information is exhibited to the user as a selection menu for each user (S508). In contrast, if there is no program or no digest candidate scene that can be delivered, an item irrelevant to the preference is exhibited to the user (S509 and S510).

When the user selects a digest that the user would like to watch in a menu on the screen of the user's mobile terminal, the user WWW server 305 issues a request for creating the digest in accordance with the user's preference. As a result, it is possible to automatically exhibit the digest menu and produce the digest for the user.

The digest processing apparatus 104 extracts an identifier of a user from the user's access information and determines what personal digest item should be exhibited to the user based upon the preference information that the user has registered in advance and the program information stored in the meta data DB 109. Based upon the determination, a request for creating a digest is issued to the scene ranking module and a personal digest is created.

For instance, it is assumed that a user having the user ID 100 has access of this system. The preference information of the user as mentioned above has been already registered in the user DB. The system searches for the preference information by setting the user ID as a search key. Then, it is examined whether or not there is a program that can be currently delivered as a digest. Also, it is determined whether or not there is a scene relevant to the user's preference information in digest scenes (digest candidate scenes) that can be delivered. If a relevant scene is found, a digest suitable for the user's preference is exhibited to the user as a selection menu. If the user selects a digest that the user would like to watch in the menu, the WWW server issues a request for creating the digest in accordance with the user's preference to the digest server. As a result, it is possible to automatically exhibit the digest menu and produce the digest for the user.

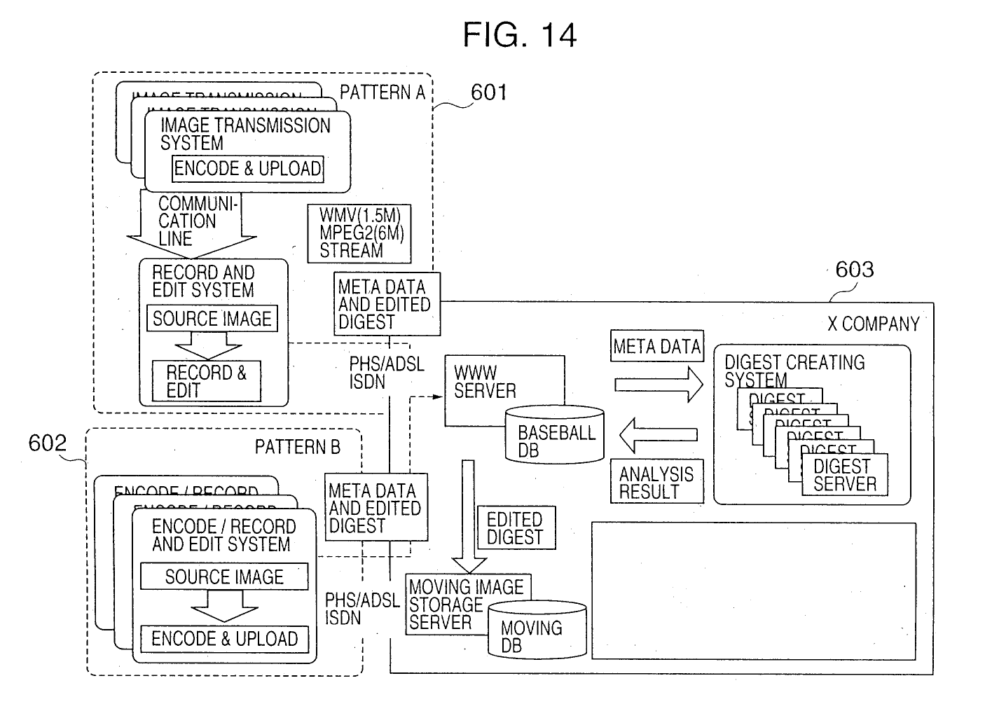

A description will now be given, with reference to FIG. 14, of storage of a moving image (digest candidate scene) and meta data in the personal digest delivery system according to the second embodiment of the present invention. In FIG. 14, those parts designated by the reference numerals 601 and 602 correspond to the field processing apparatus 101, and the X company designated by the reference numeral 603 corresponds to the digest processing apparatus 104.

In the pattern A, the field processing apparatus 101 is considered to have two separate functions as illustrated in FIG. 14: an image transmission system and a record and edit system. A terminal having an image transmission system is placed in each field, and source image data (source picture) are sent from the field to a terminal having the record and edit system, which is provided at a different location from the terminal having the image transmission system, by using the image transmission system. The terminal having the record and edit system records and edits the source picture (source image data) to generate program meta data and an edited digest (digest candidate scene) and then sends the resulting program meta data and the edited digest to the X company (digest processing apparatus 104) 603. As a result, in the pattern A, while it is necessary to prepare the number of the terminals having the image transmission system corresponding to the number of the fields, it is sufficient to prepare only one terminal having the record and edit system.

In the pattern B, the field processing apparatus 101 has only a function of the record and edit system. A terminal having the record and edit system is placed in each field. The terminal having the record and edit system records and edits a source image (source image data) in the field to generate program meta data and an edited digest (digest candidate scene) and then sends the program meta data and the edited digest to X company (digest processing apparatus 104) 603. Consequently, it is necessary to prepare the number of the terminals having the record and edit system corresponding to the number of fields.

In the X company 603, the digest servers whose number is equal to the number of games (ball parks) are driven, and the individual games are analyzed in real time At this time, even if the digest server has trouble, it is possible to read meta data in the database and analyze the meta data again. The moving image storage server transfers the edited digest scene to a server in the X company (moving image delivery processing apparatus 111).

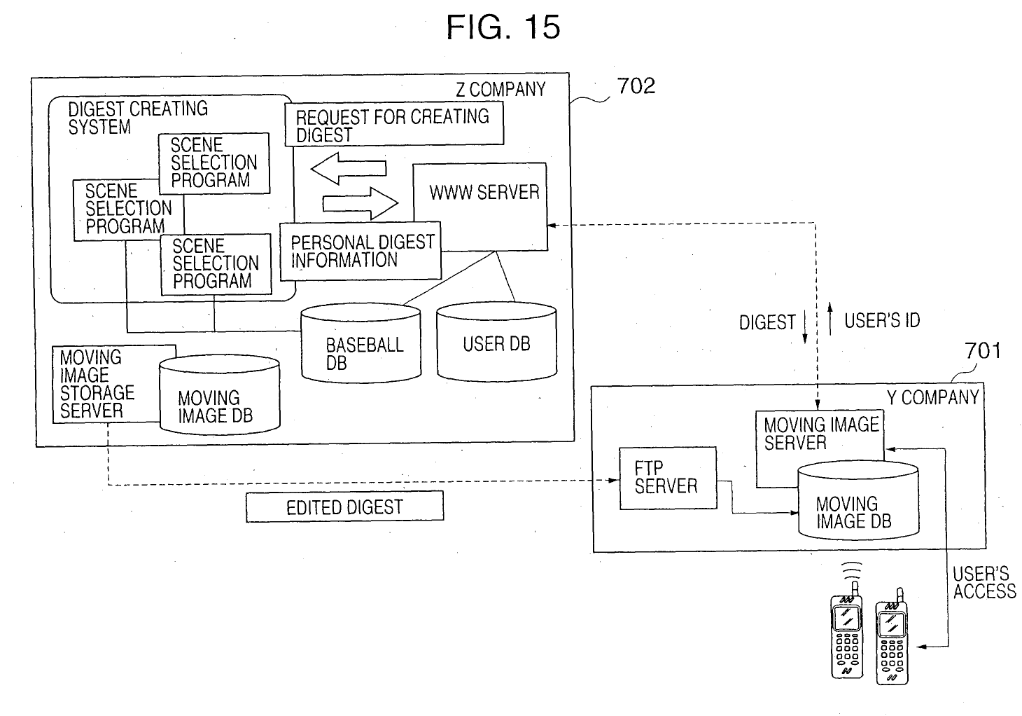

A description will now be given, with reference to FIG. 15, of the access of a user (mobile terminal). In this system, whenever the user accesses the system, a user ID is sent from a moving image server 112 of Y company (moving image delivery apparatus 111) 701 to Z company (digest processing apparatus 104) 702. In the Z company 702, the digest creation system drives a scene selection program. Based upon a request for creating a digest for an individual user, a digest candidate scene is selected for the user and is sent back to the WWW server. The WWW server creates a dynamic html page for the user and sends the page to the user.

On the other hand, the moving image storage server sends the edited digest (digest candidate scene) to the FTP server of the Y company 701. The moving image server 112 sends the moving image (digest candidate scene) that the user selects in the dynamic html page to the user.

According to the second embodiment, it is possible to provide a personal digest delivery system that can automatically create a digest and achieve prompt digest delivery in the mobile environment in which a mobile terminal is used. In the mobile environment in which there are some restrictions such as the limited display area, it is possible to efficiently create a digest reflecting the preference of a user.

The present invention is not limited to the specifically disclosed embodiments, and variations and modifications may be made without departing from the scope of the present invention.

The present application is based on Japanese priority applications No. 2002-020692 filed Jan. 29, 2002, No. 2002-097884 filed Mar. 29, 2002 and No. 2002-328715 filed Nov. 12, 2002, the entire contents of which are hereby incorporated by reference.

What is claimed is:

1. A personal digest delivery system for delivering a personal digest of an image to a mobile terminal of a user, comprising:
a field processing apparatus having a meta data creating part provided in a field in which an event to be imaged arises, the field processing apparatus generating meta data of said image, a digest candidate scene creating part extracting a portion of said image and creating a digest candidate scene, and a meta data digest candidate scene sending part sending said meta data and said digest candidate scene;
a digest processing apparatus having a meta data receiving part receiving said meta data sent by said meta data digest candidate scene sending part, a personal digest creating part creating the personal digest for the user based on said meta data and preference information of the user, a personal digest exhibiting part exhibiting said personal digest to the user, and a receiving part receiving from said user a request for delivery of moving image data; and
a moving image delivery processing apparatus having a digest candidate scene receiving part receiving said digest candidate scene from said field processing apparatus, and a moving image data delivery part delivering said moving image data formed of at least a portion of said digest candidate scene to the mobile terminal of said user.

2. The personal digest delivery system as claimed in claim 1, wherein said digest processing apparatus further has a meta data storage part storing said meta data that said meta data receiving part receives and a preference information storage part storing said preference information of said user in advance, and said personal digest creating part creates said personal digest from said meta data stored in said meta data storage part and said preference information of said user stored in said preference information storage part.

3. The personal digest delivery system as claimed in claim 1, wherein said moving image delivery processing apparatus further has a digest candidate scene storage part storing said digest candidate scene that said digest candidate scene receiving part receives, and said moving image data delivery part delivers said moving image data created from said digest candidate scene stored in said digest candidate scene storage part to said mobile terminal of said user.

4. The personal digest delivery system as claimed in claim 1, wherein said moving image data delivery part, when said receiving part of said digest processing apparatus receives a request for said moving image data delivery, reads said digest candidate scene based on said personal digest and delivers said moving image data created by editing said digest candidate scene to the mobile terminal of the user that sends said request.

5. The personal digest delivery system as claimed in claim 1, wherein said field processing apparatus is provided in a playing field of a sports program such as soccer and baseball and generates said meta data of said sports program.

6. The personal digest delivery system as claimed in claim 5, wherein said field processing apparatus sends said meta data of the sports program and said digest candidate scene to said digest processing apparatus in one of in real time and at an intermission of said sports program.

7. The personal digest delivery system as claimed in claim 1, wherein said meta data that said field processing apparatus generates are content description data describing said digest candidate scene.

8. The personal digest delivery system as claimed in claim 1, wherein said digest processing apparatus analyzes the importance of said digest candidate scene based on said meta data stored in said meta data storage part and further has a digest server writing an analysis result in said meta data storage part.

9. The personal digest delivery system as claimed in claim 8, wherein said digest server periodically examines an update of said meta data, and said digest server analyzes the importance of the digest candidate scene and writes the analysis result in said meta data storage part immediately after said meta data are updated.

10. The personal digest delivery system as claimed in claim 2, wherein said digest processing apparatus further has a scene ranking module having a function of ranking said digest candidate scene by using said preference information of said user.

11. The personal digest delivery system as claimed in claim 10, wherein said digest processing apparatus stores an identifier and information regarding a preference item of said user as preference information of said user in said preference information storage part.

12. The personal digest delivery system as claimed in claim 11, wherein said digest processing apparatus extracts an identifier of said user from access information of said user, determines an item of said personal digest to be exhibited to said user based on said preference information of said user that said user registers in advance and said meta data stored in said meta data storage part, issues a digest creating request to said scene ranking module and creates said personal digest.

13. The personal digest delivery system as claimed in claim 1, wherein a plurality of said field processing apparatuses are provided at a plurality of said fields and each of the field processing apparatuses is located in one of the fields and processes said image of an event arising in the field in which the field processing apparatus is located.

14. A personal digest delivery method for delivering a personal digest of an image to a mobile terminal of a user, the personal digest-delivery method comprising:
a meta data creating step of creating meta data of said image in a field in which an event to be imaged arises;
a digest candidate scene creating step of extracting a portion of said image and creating a digest candidate scene;
a personal digest creating step of creating a personal digest for the user based on said meta data and preference information of the user;
a personal digest exhibiting step of exhibiting said personal digest to the user; and
a moving image data delivery step of delivering moving image data created from at least a portion of said digest candidate scene to the mobile terminal of said user.
